(19) United States
(12) Patent Application Publication
(10) Pub. No.: US 2010/0235303 A1
(43) Pub. Date: Sep. 16, 2010

(54) Postal Meter Discount System and Method

(75) Inventor: Daniel Lynch, Bridgewater, CT (US)

Correspondence Address: Townsend and Townsend and Crew LLP, Two Embarcardero Center, San Francisco, CA, 94111-3834, US

(73) Assignee: Neopost Technologies, Bagneux (FR)

(21) Appl. No.: 12/403,821

(22) Filed: Mar. 13, 2009

(51) Int. Cl. G07B 17/02; G06F 15/16

(52) U.S. Cl. 705/402; 705/404; 709/204

(57) ABSTRACT

A method to provide consolidated shipping information to a server of a carrier by which a package is to be shipped in exchange for a rebate, a discount, or both, is disclosed. The method includes receiving shipping criteria including destination address information and tracking/confirmation information for the package, creating shipping payment information for the package by a postal meter, and generating consolidated shipping information from the destination address information, the tracking/confirmation information, and the shipping payment.

### BACKGROUND OF THE INVENTION

To encourage an increase in shipment revenue and collection of consolidated shipping information, shipment carriers utilize revenue sharing programs that provide either a discount or rebate to a shipment service vendor that provides user access to the carriers' service. For example, the USPS presently provides a revenue sharing rebate to online postage vendors. Some or all of the rebate may be passed on from the service vendors to the vendors' customers, i.e., the end users.

Revenue sharing typically is provided because the participating service vendors provide consolidated shipping information to the carriers, such as product/service code, destination address information, payment information, and tracking/confirmation numbers. Details of the rebate may vary by contractual agreement between the carrier and the service vendor, and are often based upon shipment characteristics. For example, the rebates may be based on any or all of regional, cumulative, and temporal contractual specifications such as revenue, quantity of packages shipped, and weight shipped. These characteristics can be included within the consolidated information provided to the carriers.

### BRIEF SUMMARY OF THE INVENTION

Embodiments of the invention may include methods, systems, and devices to generate, manipulate, and use consolidated shipping information for a package to be shipped using postage generated by a postal meter. The consolidated shipping information may be generated by a user interface, postal meter, and/or postal services vendor (also herein referred to as a “vendor”) and provided to a shipping carrier in exchange for a rebate or discount.

An embodiment of the invention includes a method to provide consolidated shipping information to a server of a carrier by which a package is to be shipped in exchange for a rebate, a discount, or both. The method includes receiving shipping criteria including destination address information and tracking/confirmation information for the package, creating shipping payment information for the package by a postal meter, and generating consolidated shipping information from the destination address information, the tracking/confirmation information, and the shipping payment.

A further embodiment of the invention includes a postal system. The postal system includes a postal meter productive of shipping payment information for a package, a user interface device connected to the postal meter, and a communication link to connect the user interface device to a postal vendor server. The user interface device is receptive of destination address information and tracking/confirmation information for the package. The postal system provides consolidated shipping information including destination address information, the tracking/confirmation information, and the shipping payment information for the package to a carrier server. A postal services vendor associated with the postal vendor server receives a discount, a rebate, or both from the carrier due to the carrier receiving the consolidated shipping information.

### BRIEF DESCRIPTION OF THE DRAWINGS

FIG. 1 shows an example of a postage shipping label according to embodiments of the invention.

FIG. 2 shows an example of a system suitable for generating and using consolidated package shipment information according to embodiments of the invention.

FIG. 3 shows an example message flow according to an embodiment of the invention in which the user interface and postal meter generate consolidated shipping information.

FIG. 4 shows an example message flow according to an embodiment of the invention in which the user interface and postal meter generate consolidated shipping information.

FIG. 5 shows an example message flow according to an embodiment of the invention in which a unique identifier is assigned to a package.

FIG. 6 shows an example message flow according to an embodiment of the invention in which a tracking server is used.

FIG. 7 shows a flowchart 700 of generalized process steps for a method of providing consolidated shipping information to a carrier in accordance with an embodiment of the invention.

FIG. 8 shows a computer suitable for use with embodiments of the present invention.

FIG. 9 shows a schematic diagram of a processing unit as shown in FIG. 8.

### DETAILED DESCRIPTION OF THE INVENTION

There are presently over 1,500,000 postage metering machines (also herein referred to as a “postal meter”) installed and in use throughout the US. As used herein, the term “postal meter” shall refer to such postal metering machines that are physically located at a user's site and capable of providing physical evidence of postage payment. These postal meters are supported by a payment infrastructure between the end user, postal service vendor and carrier, and provide many operational benefits to their users, such as consolidated billing, customer support, and financial reporting, for example. While arrangements that utilize postal meters to pay for package shipment are known, the payment and communications infrastructures are such that they have not previously been able to provide the consolidated shipping information required by carriers for rebate eligibility. Methods and systems according to the present invention provide the ability for consolidated shipping information to be provided to carriers, thus making the vendor eligible for rebates or discounts offered by the carriers.

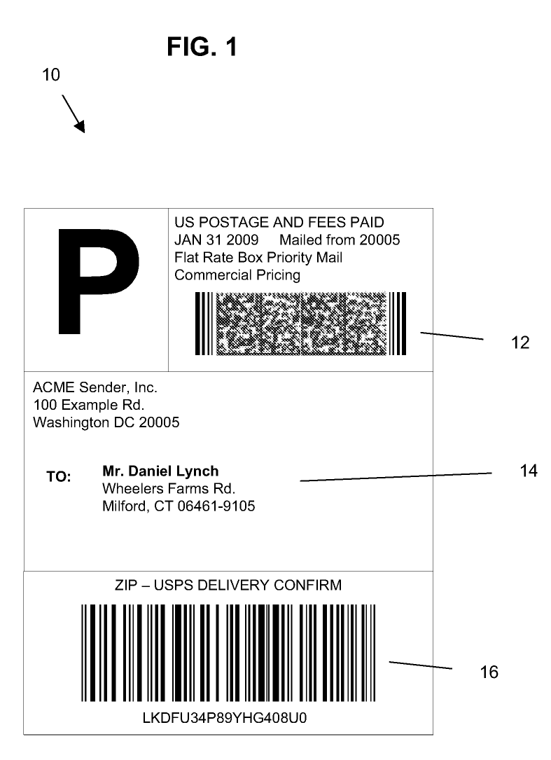

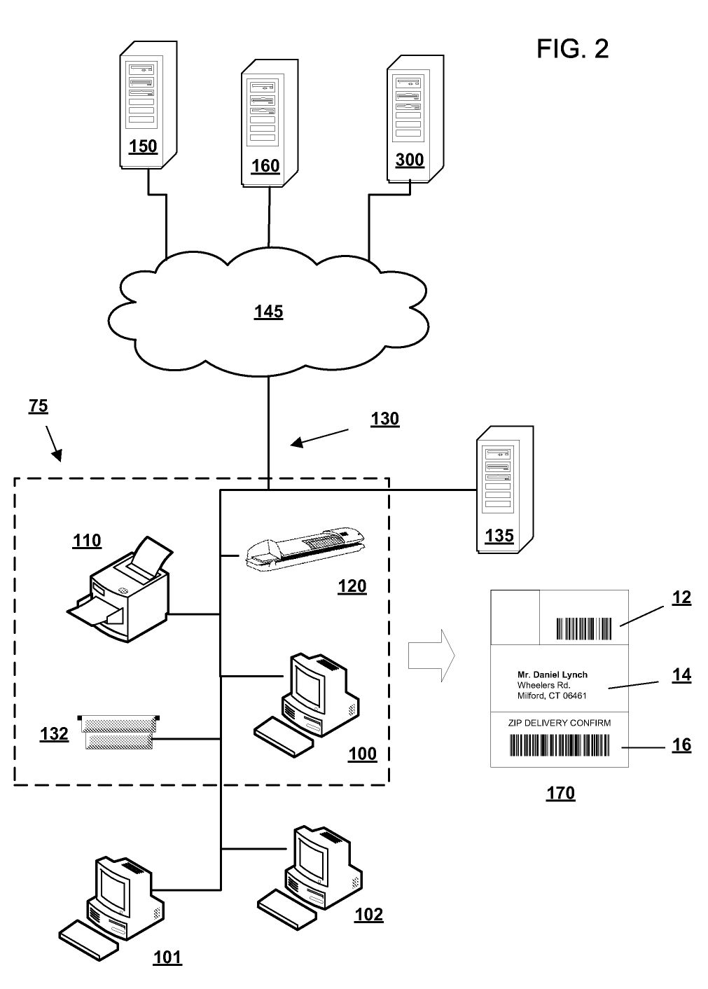

FIG. 1 shows an example of a postage shipping label 10 according to embodiments of the invention with shipping information including evidence of postage payment, (also herein referred to as “payment information”) 12, destination address information 14, and tracking/confirmation information 16. The representation of payment information 12 is shown as a machine-readable 2D barcode, but is not necessarily so limited. In similar fashion, the representation of destination address information 14 shown as human-readable text is not necessarily so limited. Further, the representation of tracking/confirmation information 16 is shown as both a machine readable 1D barcode and human readable characters, but is not necessarily limited in such fashion. Embodiments of the present invention may utilize a postal meter 120 (See FIG. 2) for postage payment and provide the shipping information 12, 14, 16 to carriers in a consolidated electronic form separately from the label 10, thereby qualifying the vendor associated with the postal meter 120 for the rebate or discount. While FIG. 1 depicts a particular layout of the shipping label 10, it will be appreciated that the scope of the invention in not so limited, and can include arrangement of the shipping information in alternate arrangements, such as to place the payment information 12 upon a package separate from the address information 14 and tracking/confirmation information 16.

Payment information 12 may be produced by a postal meter that includes a Postal Security Device (PSD). As appreciated by one of skill in the art, a PSD typically includes appropriate security to ensure that any representations of payment information 12 are genuine. For example, secure information such as ascending and descending register values, and/or a postal meter serial number which is traceable to a funding account of the user may be included within an Information Bearing Indicia (IBI) that is generated and printed under the control of the PSD. The general use and operation of PSDs to generate IBIs will be understood by one of skill in the art. Specific examples of accounting registers suitable for use in a PSD in embodiments of the invention are described in U.S. application Ser. No. 12/166,005, filed Jul. 1, 2008, and U.S. application Ser. No. 12/119,899, filed May 13, 2008, each of which is incorporated by reference in its entirety.

FIG. 2 shows an example of a system suitable for generating and using consolidated package shipment information according to embodiments of the invention. A workstation 75 may include a user interface 100, such as a personal computer, special-purpose computer, or other electronic device. The user interface 100 may be linked to and in communication with a printer 110, postal meter 120, and/or a postal scale 132. The interface 100, printer 110, postal meter 120, and postal scale 132 may be connected via a communication link, such as a network 130, by direct physical connections, or any other suitable connection. In some embodiments, the postal meter 120, printer 110, and scale 132 may be considered part of the workstation 75. In some embodiments, one, some, or all of the postal meter 120, printer 110, and scale 132 may be connected to, accessed by, and/or controlled by multiple user interfaces 100, 101, 102 such as where a shared printer is used by multiple users. As another example, a single postal meter 120 can be a shared resource among more than one workstation 75, and/or user interface 100, 101, 102, and need not be physically located near any particular workstation. In such a configuration, the shared resource may not be considered part of a single user workstation. As will be understood by one of skill in the art, a local network 130 may be used to connect one or more user interfaces, printers, scales, and postal meters. In some embodiments, multiple user interfaces 100, 101, 102 and/or workstations 75 may be connected to a user-side server 135 by either of networks 130 or 145.

The user interface 100 also may be linked to a vendor server 150, a postal carrier server 160, or both via a large-area network 145, such as the Internet, a secure Wide-Area Network, or other appropriate network. For example, the user interface 100 may be linked to one or more servers operated by a postal services vendor and/or a postal carrier.

The user interface 100 is receptive of destination address information 14 and tracking/confirmation information 16 for the package. For example, an end user may use the user interface 100 to enter appropriate shipping criteria in order to ship a package. Exemplary shipping criteria can include size, shape, weight, destination address, and desired method of shipment. Other criteria may be entered, such as origin zip code, which can be used by carriers to determine volume of shipments from a zone corresponding to the customer as well as appropriate zone to zone shipping rates. The user interface 100 may communicate with one or more of servers 135, 150, and 160 to determine appropriate shipping information based on the shipping criteria. For example, the user interface 100 may receive an estimated shipping cost, (also herein referred to as a “shipping rate”), delivery date, package pick-up information, and other shipping information. The user interface 100 may present some or all of the received information for review and/or approval by a user.

If the user desires to proceed with the package shipment, he may so indicate via the user interface 100, and the user workstation 75 may generate a shipping label 170, such as via the printer 110. As explained in further detail below, the shipping label 170 may include some or all of the payment information 12, the destination address information 14, and the tracking/confirmation information 16. For example, the label may include plain text, bar codes, two-dimensional (2D) barcodes, or other human- and/or machine-readable representations of the information 12, 14, 16.

The user interface 100 may communicate with the PSD of the postal meter 120 to obtain appropriate payment information 12 for the package shipment. The payment information 12 may be encoded within a postage indicia, as will be appreciated by one of skill in the art. The payment information 12 may then be printed upon the shipping label 170, or upon a separate label that is later affixed to the shipping label 170 or the package to be shipped. As described in further detail below, various information may be printed on the shipping label 170 by the printer 110, the postal meter 120, or both. Such embodiments support “Desktop Shipping”, in which the shipping label 170 is generated by the end user.

In some embodiments, a shipping carrier may operate a tracking server or system 300 to track postage revenue. A specific, non-limiting example of a tracking server 300 suitable for use with such an embodiment is the USPS tracking system which includes, for example, an Information Based Indicia (IBI) tracking database. As will be appreciated by one of skill in the art, an IBI (not shown) may be printed upon a shipment label 170 or other postage label, and may include a representation of the payment information 12 for the package. When a mailpiece or package having an IBI or similar indicia enters the delivery stream of the carrier, the tracking system 300 may scan the IBI and tracking/confirmation information 16 and store the IBI data, tracking/confirmation information 16, or a combination thereof. As will be understood by one of skill in the art, the tracking system 300 may include one or more tracking servers and/or tracking databases. The carrier may provide the IBI data and tracking/confirmation information available to the server 150 of the vendor associated with the postal meter 120 that printed the IBI.

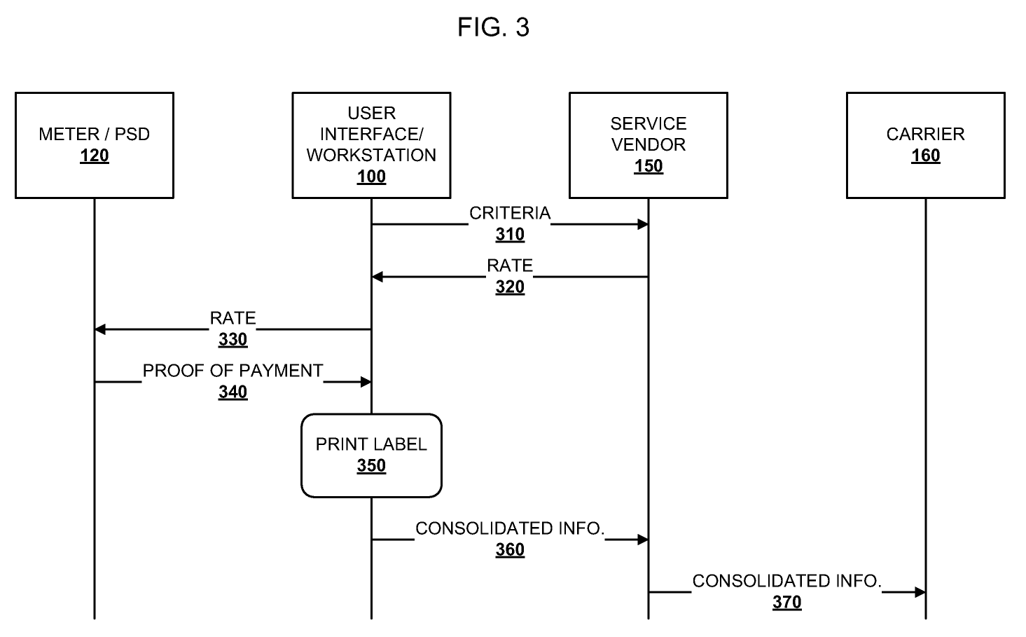

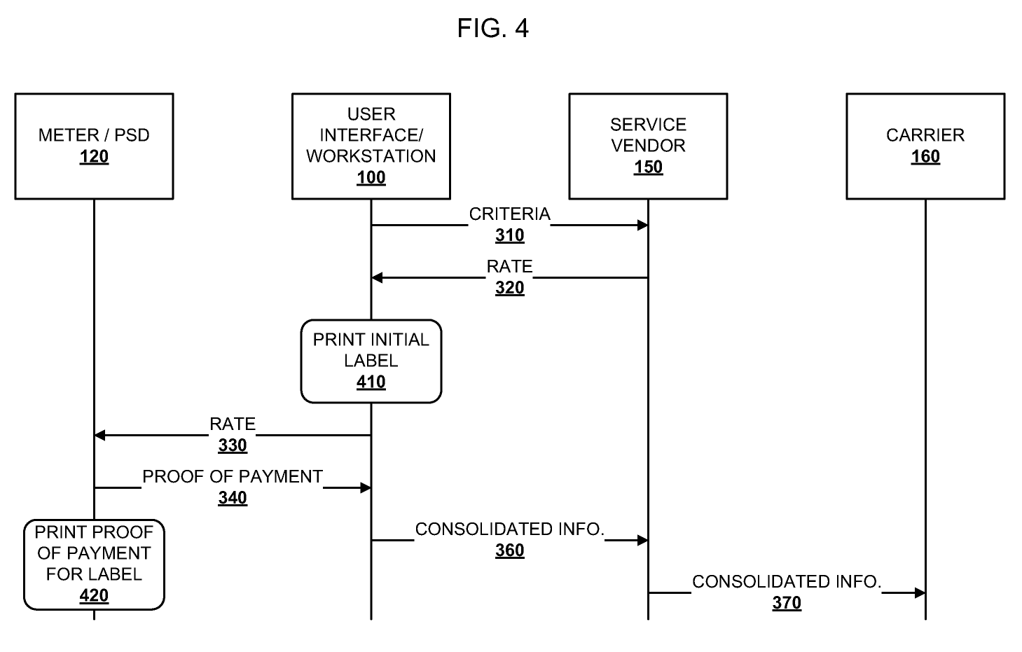

In some embodiments, the user interface 100 and postal meter 120 may generate consolidated information that the vendor may provide to the carrier, such as via server 160 for example, to obtain a rebate or discount. FIGS. 3-4 show example message flows according to embodiments of the invention in which the user interface 100 and postal meter 120 generate consolidated shipping information.

As previously described, a user may enter appropriate shipping criteria into the user interface 100 in order to ship a package. For example, the user may input criteria such as any of size, shape, weight, destination address, and desired method of shipment. At 310, the user interface 100 may then communicate with one or more of the servers 135, 150, to determine appropriate shipping information at 320. For example, the user interface 100 may receive the shipping rate, estimated shipping cost, delivery date, and/or package pick-up information from vendor server 150.

In an embodiment as shown in FIG. 3, at 330-340 the user interface 100 may communicate with the PSD of the postal meter 120 and obtain appropriate payment information 12. For example, the user interface 100 may send an appropriate rate to the PSD at 330, and receive an indicia or other proof of payment corresponding to the appropriate rate at 340. The printer 110 may then print the shipping label 170 (FIG. 2) at 350 which includes representations of the payment information 12, destination address information 14 and tracking/confirmation information 16.

Accordingly, the user interface 100 has access to all of: the payment information 12; the destination address information 14; and the tracking/confirmation information 16. At 360, the user interface 100 can provide, in consolidated form, the shipping information 12, 14, and 16 to a vendor server 150. The vendor server 150 may then, at 370, provide consolidated shipping information to the carrier server 160, thereby making the vendor eligible for the rebate. For example, the vendor may provide the consolidated shipping information in a specific electronic format as specified by the carrier.

In another embodiment as shown in FIG. 4, after receiving rate information from the vendor at 320, the user interface 100 may provide for printing of an initial label 170 at 410 that includes the destination address information 14 and tracking/confirmation information 16. The postal meter 120 may separately print a representation of the payment information 12 for use with the initial label at 420. The representation of the payment information 12 may be generated by the postal meter 120 at 420 and printed directly upon the initial shipping label 170, or it may be printed upon a separate postage label that is subsequently applied to the initial shipping label 170. If a separate label is used, the package with the initial shipping label 170 attached thereto may be transported to a location of the postal meter 120, such as a mailroom, for provision and application of the payment information 12 upon the separate label.

In an embodiment, one or more of the servers 135, 150 may provide a product code and/or unique identifier corresponding to the package to be shipped. A “product code” defines a type of carrier service provided, such as express mail. The combination of product code and unique identifier (also herein referred to as “PC/UID”) may indicate an amount of postage fee (also herein referred to as a “rate”) appropriate to ship the specific package according to the shipping criteria entered by the user.

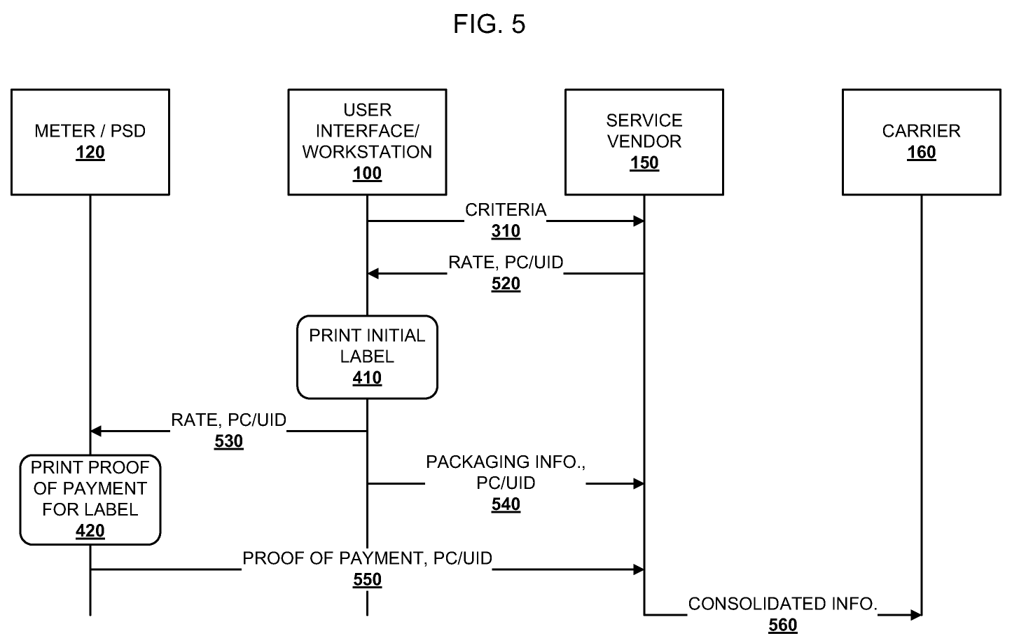

FIG. 5 shows an example of a message flow according to an embodiment of the invention in which the vendor, via server 150, assigns a PC/UID to the package. After the user interface 100 provides shipping criteria to the vendor at 310, the vendor server 150 may send appropriate rate information, such as the PC/UID, to the user interface 100 at 520. The workstation 75 may then print an initial shipping label 170 at 410 via printer 110 as previously described. The initial label 170 may include representations of the destination address information 14 and the tracking/confirmation information 16, and may further include a representation of the PC/UID, for example a barcode printed within or proximate to the area in which the payment information 12 is printed.

The user interface 100 may then send the rate and/or the product code/identifier to a postal meter 120 (including a PSD) at 530. The postal meter 120, responsive to input of the PC/UID, may print the payment information 12 at 420. As previously described, the payment information 12 may be printed directly upon the initial shipping label 170. Alternatively, it may be printed upon a separate postage label which is subsequently applied to the initial shipping label 170 or to the package to be shipped. The postal meter 120 may receive the PC/UID in a variety of manners to determine the appropriate rate and to associate the PC/UID with the appropriate payment information 12 to be placed upon the label 170. Examples of such manners include manual entry, scanning the representation, via an RFID tag, or any other suitable manner. The package, including the shipment label 170 with the payment information 12, may then be provided to the carrier for transport and delivery.

In some embodiments, the package and the shipment label 170 may proceed from a location other than that of the user. For example, the shipment label 170 may be printed at a printer located remotely with respect to the user interface 100 used to generate the shipment label 170. The package and label 170 may subsequently be combined, such as based upon the unique identifier.

Accordingly, the user interface 100 has access to the destination address information 14, the tracking/confirmation information 16, and the PC/UID corresponding to the package. The user interface 100 may then provide the shipping information 14, 16 and the combination of product code and unique identifier to the vendor server 150 at 540. The postal meter 120 may separately provide the PC/UID and payment information 12 to the vendor server 150 at 550. The vendor server 150 may then consolidate the information 12, 14, 16 and provide the consolidated information to the carrier server 160 at 560, thereby making the vendor eligible for the rebate.

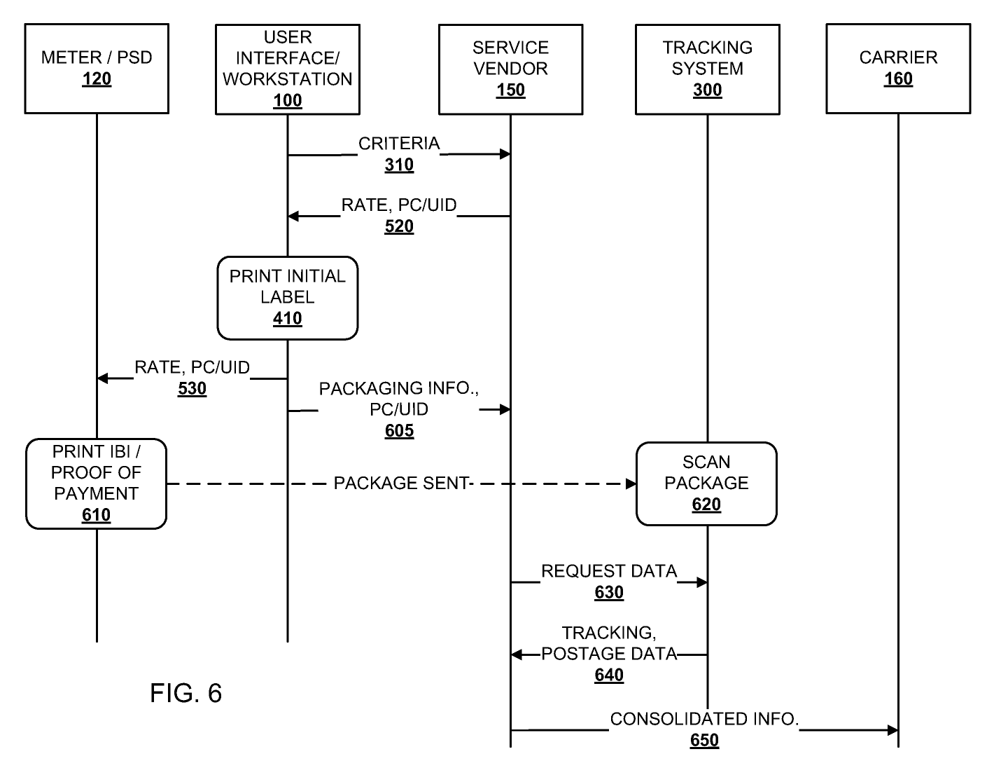

In another embodiment, a tracking system 300 may be used as part of a process to generate the consolidated information. As previously described, an example of a tracking server 300 that is suitable for use with embodiments of the invention is the type used in the USPS IBI tracking system. FIG. 6 shows an example of a message flow according to an embodiment of the invention in which a tracking server 300 is used to manage information associated with shipped packages.

As previously described, the workstation 75 may send shipping criteria to one or more of the servers 135, 150, at 310, receive the PC/UID for the package at 520, and print an initial shipping label 170 including representations of the destination address information 14 and the tracking/confirmation information 16, at 410. The shipping label 170 may further include the PC/UID. The user interface 100 may then make available an appropriate rate and/or the PC/UID to the PSD of the postal meter 120 at 530, to thereby allow the postal meter 120 to print an IBI including the payment information 12 at 610. As previously described, the payment information 12 printed by the postal meter 120 may be printed directly upon the initial shipping label 170 created at 410, or it may be printed upon a separate postage label, which is subsequently applied to the initial shipping label 170. As described above, the postal meter 120 may receive the PC/UID in a variety of manners to associate the PC/UID with the appropriate payment information 12 to be placed upon the label 170. The user interface 100 provides the destination address information 14, the tracking/confirmation information 16, and the PC/UID corresponding to the package to the vendor server 150 at 605. The package including the shipment label 170 with the payment information 12 may then be provided to the carrier for transport and delivery.

While the package is in transit, the label 170 upon the package may be obtained via scanning by a tracking system 300 at 620. The tracking system 300 may be operated by a carrier to track a status of postage revenue. For example, the tracking system 300 may scan an IBI (including payment information 12) and/or tracking information, such as tracking/confirmation information 16, and store the IBI data and tracking/confirmation information 16 within an IBI tracking database. The carrier may provide the stored IBI data (including payment information 12) and tracking/confirmation information 16 to the vendor server 150. For example, at 630 the vendor server 150 associated with the postal meter 120 may poll the tracking system 300 for IBI and/or tracking/confirmation information 16. At 640, the tracking system 300 may provide appropriate data (tracking/confirmation and payment information 16, 12) associated with the package sent with the label 170 printed at 410 and payment information 12 printed at 610.

Thus, the vendor server 150 has access to tracking/confirmation and payment information 16, 12 stored in the IBI tracking database. Therefore, using the tracking/confirmation information 16, the vendor server 150 can link the destination address information 14 and tracking/confirmation 16 received from the user interface at 605, to the information 16, 12 received from the tracking 300 system at 640. Accordingly, the vendor server 150 may then collect and consolidate respective shipping information 12, 14, 16 and provide consolidated shipping information 12, 14, 16 to carrier server 160 at 650, thereby making the vendor eligible for the rebate.

In an embodiment, the vendor server 150 verifies that the amount of postage paid (as indicated by the payment information 12 on the package and obtained by the tracking server 300) matches the amount determined by the vendor server 150 at 520 to be sufficient to pay for shipment of the package based upon the shipment criteria. Thus, the vendor may ensure that the proper payment amount was applied to provide for shipment of the package, and thereby assist the carrier in detection and auditing of potential postage fraud.

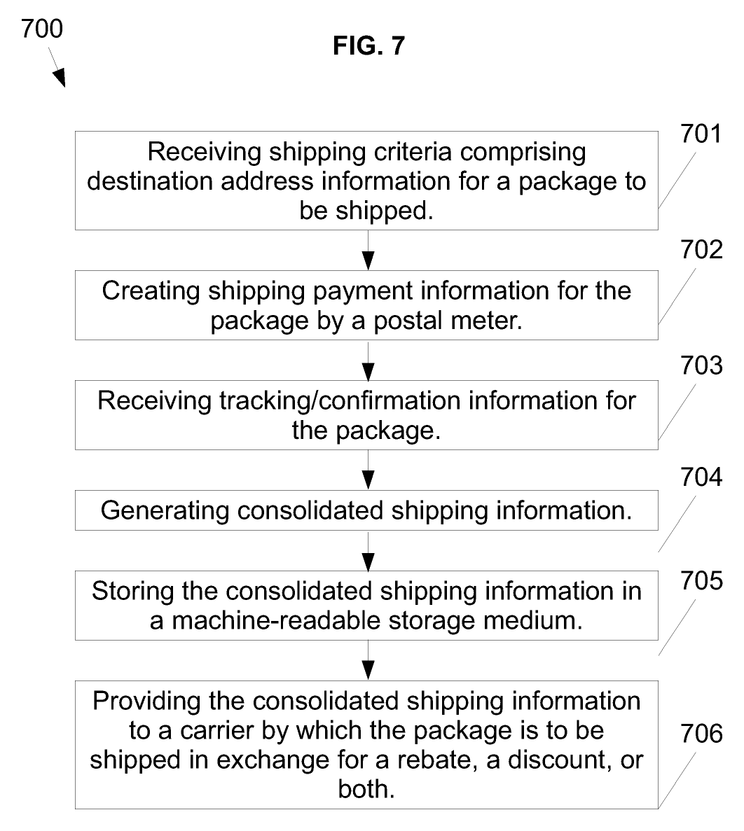

In view of the foregoing, embodiments of the invention facilitate a method of providing consolidated shipping information to a carrier in accordance with embodiments of the invention. FIG. 7 depicts an example flowchart 700 of generalized process steps for such methods.

The process begins at step 701 with receiving shipping criteria comprising destination address information 14 for a package to be shipped. The destination information may be input via user interface 100, and received by vendor server 150. The process continues at step 702 with creating shipping payment information 12 for the package by the postal meter 120. At step 703, the process includes receiving tracking/confirmation information 16 for the package at the vendor server 150. At step 704, consolidated shipping information is generated from the destination address information 14, the tracking/confirmation information 16, and the shipping payment information 12 created by the postal meter 120. At step 705, the process includes storing the consolidated shipping information in a machine-readable storage medium, such as within the server 150. The process concludes at step 706 with providing the consolidated shipping information to the server 160 of the carrier by which the package is to be shipped, in exchange for a rebate, a discount, or both.

In some embodiments, the destination address information 14 and tracking/confirmation information 16 are received by the vendor server 150 from the user interface 100 via network 145. In some embodiments, (such as those depicted by the message flows of FIGS. 3 and 4) the payment information 12 may be received by the user interface 100 at 340. In some other embodiments, (such as depicted by the message flow of FIG. 5), the payment information may be received by the vendor server 150 from the postal meter 120, such as at 550, for example. In yet other embodiments (such as depicted by the message flow of FIG. 6), the payment information 12 may be received by the vendor server 150 from the tracking system 300, such as at 640, for example.

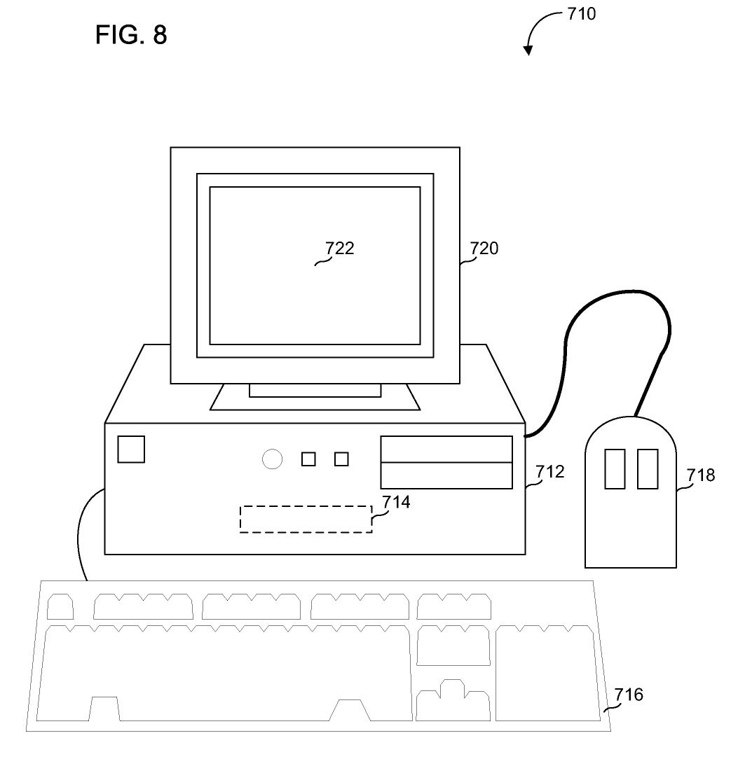

FIG. 8 shows a computer suitable for use with embodiments of the present invention. The computer 710 may include a processing unit 712, which may include one or more computer readable storage media 714. The computer may interface with a human operator via an output 720, which may include a visual display 722 to display text, graphics, video, and other visual data. The computer may receive input via a mouse 718 and/or a keyboard 716. The general operation of the computer 710 will be understood to one of skill in the art. The computer 710 may be, for example, part of the user interface 100 and/or workstation 75 as previously described. For example, the computer 710 may execute various instructions to interface with a user, postal meter, printer, postal scale, and other components of the system.

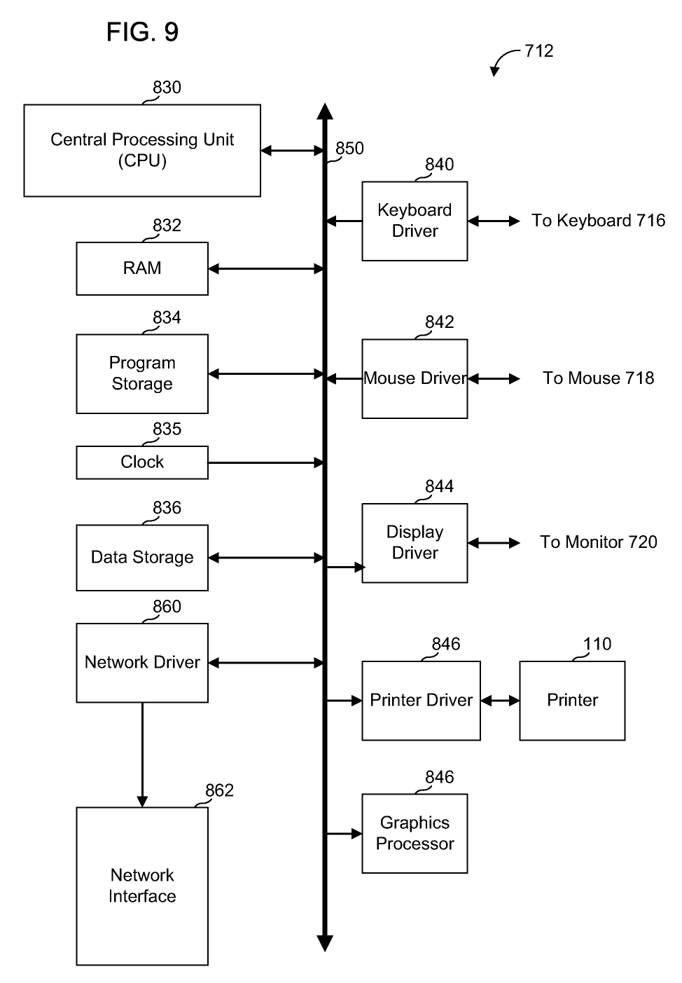

FIG. 9 shows a schematic diagram of the processing unit 712. A central processing unit 830 may communicate with various other components via a main bus 850 and other suitable communication lines (not shown). Data may be stored in volatile memory such as RAM 832, program storage 834 and/or data storage 836. The program storage 834 and/or data storage 836 may include various types of computer-readable media, such as CD-ROMs or other type of optical disks, floppy diskettes, ROMs, RAMs, EPROMs, EEPROMs, magnetic or optical cards and drives, flash memory, or other types of machine-readable mediums suitable for storing electronic instructions. Computer-readable instructions may be stored in the program storage 834. When executed by the computer, these instructions may cause the computer to implement specific methods as described herein, and may cause the computer to operate in accordance with those methods. In an embodiment, execution of the instructions stored in the program storage 834 may transform a general-purpose computer into a computer configured to perform one or more methods embodied by the instructions. A clock 835 may be used to synchronize operation of the other elements of processing unit 712. A network driver 860 may manage connections between a network interface 862, such as a TCP/IP or other suitable interface, to allow the computer to communicate with other computers, operators, or other entities. A keyboard driver 840 may communicate with the keyboard 716 to receive input from an operator. A mouse driver 842 may manage communication with the mouse 718 to coordinate reception of input signals. A display driver 844 may manage communications between the processing unit 712 and the monitor 720, such as to display appropriate output on the monitor 720. Similarly, a printer driver 846 may manage communications with a printer 110. A graphics processor 846 may generate and manage manipulation and display of graphical elements such as 2D images, 3D images and objects, and other visual elements. The general operation of the various components shown in FIG. 9 otherwise will be understood by one of skill in the art.

An embodiment of the invention may be embodied in the form of computer-implemented processes and apparatuses for practicing those processes. Embodiments of the present invention may also be embodied in the form of a computer program product having computer program code containing instructions embodied in tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing the invention. Embodiments of the invention also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A computer-implemented method comprising:
receiving shipping criteria comprising destination address information for a package to be shipped;
creating shipping payment information for the package by a postal meter;
receiving tracking/confirmation information for the package;
generating consolidated shipping information from the destination address information, the tracking/confirmation information, and the shipping payment information created by the postal meter;
storing the consolidated shipping information in a machine-readable storage medium; and
providing the consolidated shipping information to a server of a carrier by which the package is to be shipped in exchange for a rebate, a discount, or both.

2. The method of claim 1, wherein the destination address information and the tracking/confirmation information is received by a postal vendor server from a user interface device.

3. The method of claim 2, wherein the shipping payment information is received by the user interface device from the postal meter.

4. The method of claim 1, further comprising:
receiving at a postal vendor server a first message comprising a unique identifier associated with the package, the tracking/confirmation information, and the destination address information; and
receiving at the postal vendor server a second message comprising the unique identifier and the shipping payment information.

5. The method of claim 4, wherein the first message is received from a user interface device and the second message is received from the postal meter.

6. The method of claim 1, wherein the tracking/confirmation information is received by a postal vendor server from a tracking system.

7. The method of claim 6, wherein the tracking system is operated by the carrier.

8. The method of claim 6, further comprising:
obtaining the shipping payment information from the package by the tracking system.

9. The method of claim 8, further comprising verifying, via the tracking system, that the obtained shipping payment information represents an amount of postage sufficient to pay for shipment of the package in accordance with the shipping criteria.

10. The method of claim 8, wherein the obtained shipping payment information is received by the postal vendor server.

11. The method of claim 1, further comprising providing a shipping rate based on the shipping criteria, wherein the shipping payment information created by the postal meter is based on the shipping rate.

12. The method of claim 1, further comprising verifying that the shipping payment information represents an amount of postage sufficient to pay for shipment of the package.

13. A postal system comprising:
a postal meter productive of shipping payment information for a package;
a user interface device connected to the postal meter, the user interface device receptive of destination address information and tracking/confirmation information for the package; and
a communication link to connect the user interface device to a postal vendor server;
wherein the postal system provides consolidated shipping information for the package to a carrier server, the consolidated shipping information comprising the destination address information, the tracking/confirmation information, and the shipping payment information; and
wherein a postal services vendor associated with the postal vendor server receives a discount, a rebate, or both from the carrier due to the carrier receiving the consolidated shipping information.

14. The postal system of claim 13, wherein the postal vendor server receives the destination information and the tracking/confirmation information from the user interface device.

15. The postal system of claim 13, wherein:
the user interface device is receptive of a unique identifier associated with the package, and provides the unique identifier, the destination address information, and the tracking/confirmation information to the postal vendor server.

16. The postal system of claim 15, wherein the postal meter is receptive of the unique identifier and provides the unique identifier with corresponding shipping payment information to the postal vendor server.

17. The postal system of claim 13, further comprising a tracking system that obtains the tracking/confirmation information and the shipping payment information from the package;
wherein the user interface device provides the destination address information and the tracking/confirmation information to the postal vendor server; and
wherein the tracking system provides the obtained tracking/confirmation information and the obtained shipping payment information to the postal vendor server.

18. The postal system of claim 17, wherein the tracking system is operated by the carrier.

19. The postal system of claim 17, wherein:
the postal vendor server is receptive of the obtained shipping payment information from the tracking system and verifies that the obtained shipping payment information represents an amount of postage sufficient to pay for shipment of the package.

20. The postal system of claim 13, wherein the postal meter is provided to a user by the postal services vendor, and the consolidated shipping information is generated by the postal vendor server.
